(19) United States
(12) Patent Application Publication
(10) Pub. No.: US 2014/0126830 A1
(43) Pub. Date: May 8, 2014

(54) INFORMATION PROCESSING DEVICE, INFORMATION PROCESSING METHOD, AND PROGRAM

(71) Applicant: SONY CORPORATION, Minato-ku (JP)

(72) Inventors: Hisahiro SUGANUMA, Tokyo (JP); Yuichi KAGEYAMA, Tokyo (JP); Yoshiki TANAKA, Kanagawa (JP); Mitsuru TAKEHARA, Tokyo (JP)

(73) Assignee: SONY CORPORATION, Minato-ku (JP)

(21) Appl. No.: 14/030,436

(22) Filed: Sep. 18, 2013

(30) Foreign Application Priority Data
Nov. 8, 2012 (JP) 2012-245980

(51) Int. Cl. G06K 9/62

(52) U.S. Cl. CPC G06K 9/627
USPC 382/225

(57) ABSTRACT

There is provided an information processing device, including a cluster reconfiguration determining unit that, in a case where new data having positional information in a feature amount space is added to a data group in which each data has positional information in the feature amount space and is classified into a cluster based on a distance in the feature amount space, decides that a candidate cluster is to be reconfigured when the new data is classified into the cluster if there are a plurality of candidate clusters into which the new data is classifiable based on the distance in the feature amount space among the clusters.

### CROSS REFERENCE TO RELATED APPLICATIONS

This application claims the benefit of Japanese Priority Patent Application JP 2012-245980 filed Nov. 8, 2012, the entire contents of which are incorporated herein by reference.

### BACKGROUND

The present disclosure relates to an information processing device, an information processing method, and a program.

A technique of classifying data having feature amounts into clusters is used in various situations. For example, a cluster into which data is classified is decided based on a distance between pieces of data in a feature amount space expressed by feature amounts of the each data. Such a technique has been frequently used in a field of image processing. For example, JP 2010-3021A discloses a technique of obtaining data of a person who has appeared by detecting a face image included in each frame of a video stream and classifying the face image into a cluster.

### SUMMARY

In recent years, techniques of uploading an image captured by a camera equipped in a mobile terminal such as a mobile telephone (a smart phone) to a server have been widely proliferated. For example, the server provides a large-capacity storage in which a user can store a huge amount of images or provides a service that makes it possible to share stored images with another user. Even for the image stored as described above, for the sake of convenience of image browsing by the user, there is a demand for a technique of classifying images in which the same person is shown or images captured at similar places/times into the same cluster.

In this case, an image serving as a clustering target is data which is large in number and sequentially being added. Thus, it is not realistic to perform clustering on all images each time a new image is added. In this regard, for an added image, for example, a technique of calculating a distance in a feature amount space with an image of an already formed cluster and deciding a cluster to classify based on the distance is considered. However, when clustering is sequentially performed on data added as described above, a cluster formed as a result is likely to be divided more finely than when clustering is performed collectively including added data. In other words, for example, images including the same person are often classified into different clusters.

It is desirable to provide an information processing device, an information processing method, and a program, which are novel and improved and capable of classifying sequentially added data into appropriate clusters.

According to an embodiment of the present disclosure, there is provided an information processing device, including a cluster reconfiguration determining unit that, in a case where new data having positional information in a feature amount space is added to a data group in which each data has positional information in the feature amount space and is classified into a cluster based on a distance in the feature amount space, decides that a candidate cluster is to be reconfigured when the new data is classified into the cluster if there are a plurality of candidate clusters into which the new data is classifiable based on the distance in the feature amount space among the clusters.

According to an embodiment of the present disclosure, there is provided an information processing method, including, in a case where new data having positional information in a feature amount space is added to a data group in which each data has positional information in the feature amount space and is classified into a cluster based on a distance in the feature amount space, deciding that a candidate cluster is to be reconfigured when the new data is classified into the cluster if there are a plurality of candidate clusters into which the new data is classifiable based on the distance in the feature amount space among the clusters.

According to an embodiment of the present disclosure, there is provided a program causing a computer to perform a function of, in a case where new data having positional information in a feature amount space is added to a data group in which each data has positional information in the feature amount space and is classified into a cluster based on a distance in the feature amount space, deciding that a candidate cluster is to be reconfigured when the new data is classified into the cluster if there are a plurality of candidate clusters into which the new data is classifiable based on the distance in the feature amount space among the clusters.

According to embodiments of the present disclosure, it is possible to classify sequentially added data into appropriate clusters.

### BRIEF DESCRIPTION OF THE DRAWINGS

FIG. 1 is a block diagram illustrating a schematic functional configuration of a server according to a first embodiment of the present disclosure;

FIG. 2 is a diagram illustrating an example of an inter-image distance calculated in the first embodiment of the present disclosure;

FIG. 3 is a diagram illustrating an example of a similarity score calculated in the first embodiment of the present disclosure;

FIG. 4 is a diagram for describing a cluster reconfiguration determination in the first embodiment of the present disclosure;

FIG. 5 is a flowchart illustrating an outline of processing of the server according to the first embodiment of the present disclosure;

FIG. 6 is a block diagram illustrating a schematic functional configuration of a server according to a second embodiment of the present disclosure;

FIG. 7 is a diagram illustrating an exemplary distance matrix generated in the second embodiment of the present disclosure;

FIG. 8 is a diagram illustrating an exemplary predictive distance matrix generated in the second embodiment of the present disclosure;

FIG. 9 is a diagram for describing an exemplary matrix calculation in the second embodiment of the present disclosure;

FIG. 10 is a diagram for describing an exemplary repetitive recalculation of a matrix in the second embodiment of the present disclosure;

FIG. 11 is a diagram for describing a first example of an additional configuration in the second embodiment of the present disclosure;

FIG. 12 is a diagram for describing a second example of an additional configuration in the second embodiment of the present disclosure;

FIG. 13 is a diagram for describing a third example of an additional configuration in the second embodiment of the present disclosure;

FIG. 14 is a diagram for describing a third example of an additional configuration in the second embodiment of the present disclosure;

FIG. 15 is a flowchart illustrating an outline of processing of the server according to the second embodiment of the present disclosure; and

FIG. 16 is a block diagram for describing a hardware configuration of an information processing device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will proceed in the following order.

1. First embodiment

1-1. Functional configuration

1-2. Processing flow

2. Second embodiment

2-1. Functional configuration

2-2. Exemplary matrix calculation

2-3. Additional exemplary matrix calculation

2-4. Processing flow

3. Hardware configuration

4. Supplement

### 1. First Embodiment

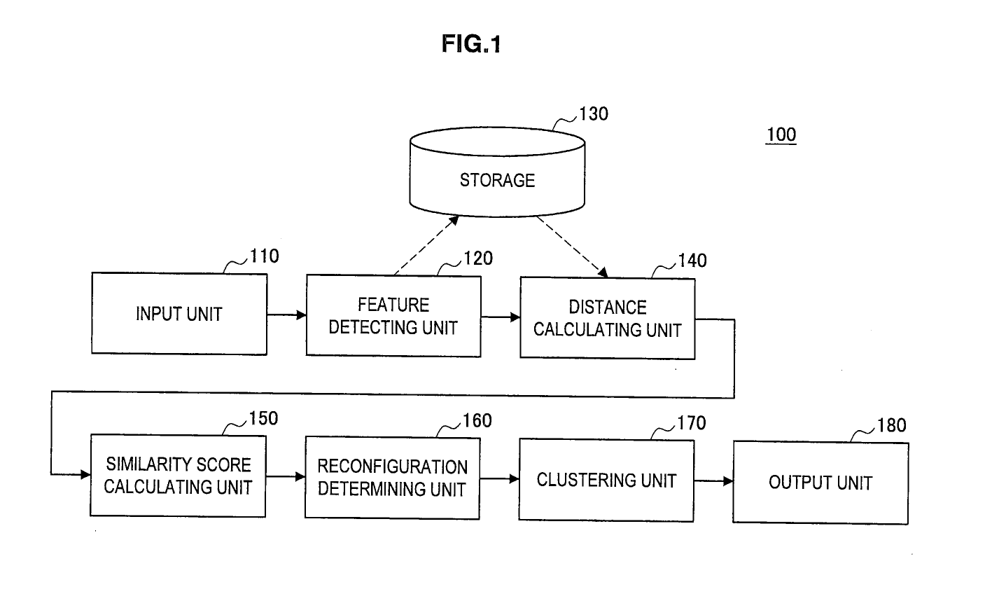

First of all, a first embodiment of the present disclosure will be described with reference to FIGS. 1 to 5. The present embodiment relates to a server that receives input of an image from a user, and outputs a result of clustering an image. The server may be implemented by a single information processing device or may be implemented by a combination of a plurality of information processing devices connected via a wired or wireless network. An exemplary hardware configuration for implementing each information processing device will be described later.

1-1. Functional Configuration

FIG. 1 is a block diagram illustrating a schematic functional configuration of a server according to the first embodiment of the present disclosure. As described above, the server 100 may be implemented by a single information processing device or a combination of a plurality of information processing devices. In the latter case, a functional configuration of the server 100 which will be described below may be implemented by a single information processing device or may be implemented such that a single functional component may be dispersed among a plurality of information processing devices.

The server 100 includes an input unit 110, a feature detecting unit 120, a storage 130, a distance calculating unit 140, a similarity score calculating unit 150, a reconfiguration determining unit 160, a clustering unit 170, and an output unit 180 as functional components. The respective functional components will be described below.

The input unit 110 receives an image input by the user. For example, an input image may be one in which an image captured by the user using a camera equipped in a mobile terminal is uploaded directly after shooting. Further, for example, an input image may be an image which has been shot in the past by the user and has been arbitrarily transmitted through a terminal device such as a personal computer (PC) by the user. In any case, the input unit 110 temporally disperses and sequentially receives input of images. Here, “sequentially” refers to an input state in which one or more images are added and input when already clustered images are stored in the storage 130 of the server 100. Thus, all images stored in the storage 130 may not be sequentially input (may be sequentially input), and intervals at which images are input may not be constant. For example, the input unit 110 is implemented by a communication device that performs communication with a terminal device that transmits an image.

The feature detecting unit 120 extracts feature amounts of an image received by the input unit 110. Here, feature amounts to be extracted are all feature amounts related to an image and may be expressed in a feature amount space using an arbitrary-dimensional vector. Thus, each image from which feature amounts are extracted has positional information in the feature amount space. Further, the feature amounts may be feature amounts of the whole image or may be feature amounts of a face region of a subject. For example, the feature amounts may be extracted using various known techniques such as techniques disclosed in JP 2010-3021A and JP 2008-77536A. The feature detecting unit 120 stores the detected feature amounts in the storage 130 in association with an image. For example, the feature detecting unit 120 is implemented by a central processing unit (CPU) operating according to a program stored in a memory.

The storage 130 stores a variety of data related to processing of the server 100. For example, the storage 130 stores an image received by the input unit 110. Further, the storage 130 stores feature amounts of an image detected by the feature detecting unit 120 in association with the image. Further, the storage 130 stores an inter-image distance calculated by the distance calculating unit 140 which will be described later, a similarity score calculated by the similarity score calculating unit 150, a result of clustering performed by the clustering unit 170, and the like. Data already stored in the storage 130 has already been subjected to clustering by the clustering unit 170. For example, the clustering is based on the inter-image distance calculated by the distance calculating unit 140 or the similarity score calculated by the similarity score calculating unit 150 based on the inter-image distance. Further, only data exchange among the feature detecting unit 120, the distance calculating unit 140, and the storage 130 is illustrated in FIG. 1, but the storage 130 can exchange data with the remaining components of the server 100 as well.

The distance calculating unit 140 calculates an inter-image distance between an image received by the input unit 110 and an image previously stored in the storage 130. In the present specification, a distance between positions represented by vectors of feature amounts of two images in the feature amount space is referred to as an inter-image distance. The distance calculating unit 140 may calculate inter-image distances between a newly received image and some images extracted from among images stored in the storage 130 according to a predetermined criterion. In this case, for example, an image in which feature amounts used to calculate the inter-image distance can be more accurately detected is extracted as a target image, and an image having a feature representing each of clusters into which images stored in the storage 130 are classified or a non-blurred (clear) image, or an image in which face parts (for example, eyes, a nose, a mouth, and a chin) are all detected when a subject's face is a target are extracted as target images. For example, the distance calculating unit 140 is also implemented by a CPU operating according to a program stored in a memory.

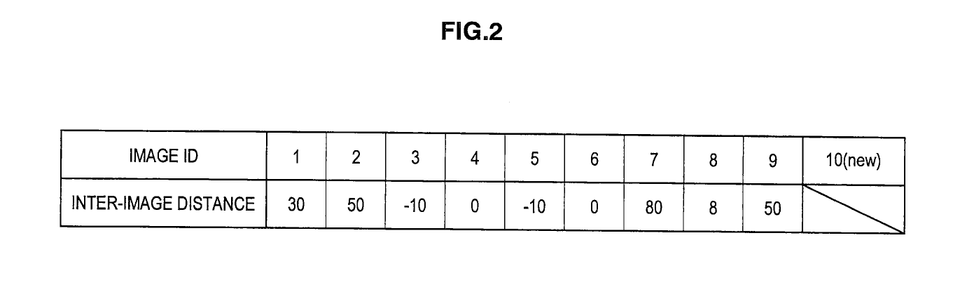

Here, an example of the inter-image distance calculated by the distance calculating unit 140 is illustrated in FIG. 2. FIG. 2 is a diagram illustrating an example of the inter-image distance calculated in the first embodiment of the present disclosure. In the example illustrated in FIG. 2, inter-image distances between a newly received image (an image ID “10”) and images (image IDs “1” to “9”) previously stored in the storage 130 are calculated. Further, the inter-image distance may be expressed by a predetermined range (for example, −100 to +100) as illustrated in FIG. 2 or may be expressed by a coordinate system of a feature amount space In the example illustrated in FIG. 2, as a value of the inter-image distance is positive and increases, similarity between feature amounts of target images increases. Thus, in this case, it can be understood that an image having feature amounts most similar to a newly received image is an image of an image ID “7” in which the largest positive inter-image distance “80” is calculated.

The similarity score calculating unit 150 calculates a similarity score between the image received by the input unit 110 and the image previously stored in the storage 130. In the present specification, a binary score representing whether two images are similar to each other is referred to as a “similarity score.” The similarity score calculating unit 150 calculates the similarity score based on the distance between images calculated by the distance calculating unit 140. More specifically, the similarity score calculating unit 150 may set a threshold value to the inter-image distance, and may set a similarity score between two images determined as being similar to each other through the threshold value “1” and set a similarity score between two images determined as not being similar to each other through the threshold value “0.” Here, the similarity score calculating unit 150 may calculate a similarity score between a newly received image and some images extracted from among images stored in the storage 130 according to a predetermined criterion, similarly to the distance calculating unit 140. For example, the similarity score calculating unit 150 is also implemented by a CPU operating according to a program stored in a memory.

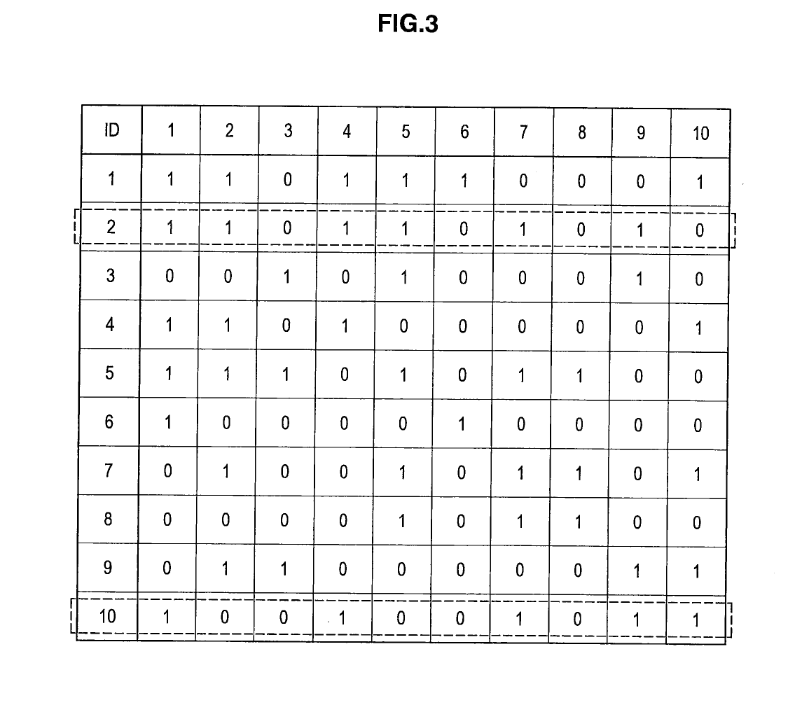

Here, an example of the similarity score calculated by the similarity score calculating unit 150 is illustrated in FIG. 3. FIG. 3 is a diagram illustrating an example of the similarity score calculated in the first embodiment of the present disclosure. In the example illustrated in FIG. 3, similarity scores between a newly received image (the image ID “10”) and the image previously stored in the storage 130 (the image IDs “1” to “9”) are calculated. Further, there is no correlation between the numbers in the example of FIG. 2 and the numbers in the example of FIG. 3.

FIG. 3 illustrates similarity scores as a matrix in which similarity scores between images of the image IDs “1” to “9” are added. Since items in a row are the same as items in a column, the matrix is a symmetric matrix. A tendency of similarity between each image and other images can be understood from the similarity score matrix. For example, the image of the image ID “10” is similar to the images of the image IDs “1,” “4,” “7,” “9,” and “10.” Meanwhile, the image of the image ID “2” is similar to the images of the image IDs “1,” “2,” “4,” “5,” “7,” and “9.” The images are not similar to each other according to the inter-image distance. However, considering a similarity tendency with the remaining images, all the images similar to the image of the image ID “10” are included in the images similar to the image of the image ID “2,” and the images have a relatively high correlation. As described above, using a correlation of a similarity score, similarity of an image can be measured from a different point of view from the inter-image distance.

The reconfiguration determining unit 160 determines a cluster to be reconfigured from among clusters into which the images previously stored in the storage 130 are classified when the images received by the input unit 110 are classified into a cluster. More specifically, when a plurality of clusters serving as a candidate of a cluster into which a newly received image is classified are extracted, the reconfiguration determining unit 160 decides that the plurality of extracted clusters are to be reconfigured based on the distance between images calculated by the distance calculating unit 140 or the similarity score calculated by the similarity score calculating unit 150. When a cluster is a reconfiguration target, an image classified into a corresponding cluster enters a state in which a classification into a cluster is not performed, and clustering is performed again on the images and a newly received image through the clustering unit 170 which will be described later. For example, the reconfiguration determining unit 160 is also implemented as a CPU operates according to a program stored in a memory.

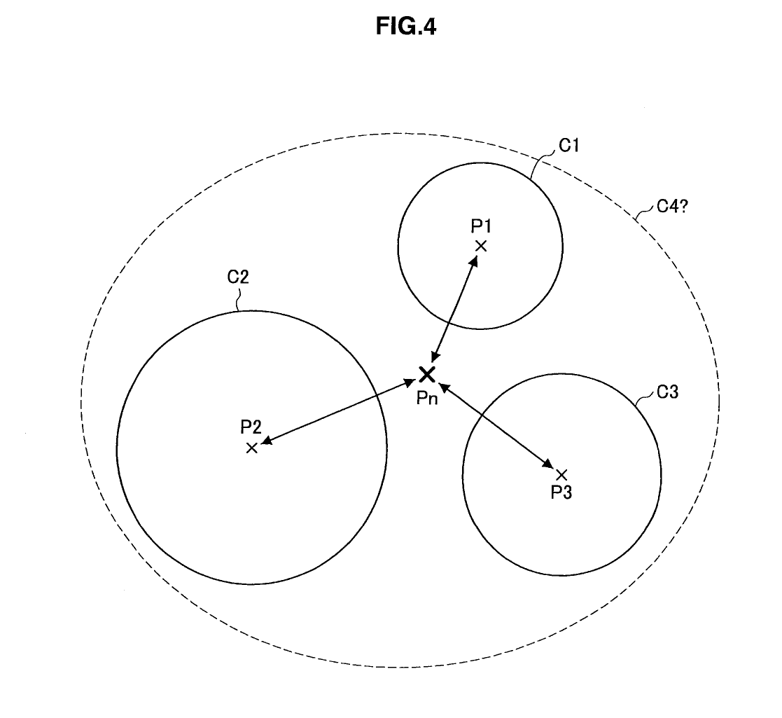

Here, a cluster reconfiguration determination of the reconfiguration determining unit 160 will be further described with reference to FIG. 4. FIG. 4 is a diagram for describing a cluster reconfiguration determination in the first embodiment of the present disclosure. In the example illustrated in FIG. 4, for a newly received image Pn, a cluster C1 having an image P1 as a representative image, a cluster C2 having an image P2 as a representative image, and a cluster C3 having an image P3 as a representative image are candidates of a cluster to classify. Here, when a cluster into which the image Pn is classified is decided simply based on the inter-image distance or the similarity score, the image Pn is added to any one cluster, and the three consecutive clusters C1 to C3 coexist.

However, if the image Pn exists from the beginning, a result of clustering may change. For example, when the image Pn is present at approximately the middle of the clusters C1 to C3 from the beginning, the clusters C1 to C3 may be formed as a single cluster C4 including the clusters rather than different clusters. However, when the newly received image Pn is simply classified into the “most similar cluster,” a state in which clusters that should normally be united are finely divided remains until clustering is re-executed on all images. When the number of images is large, since it takes time to execute clustering on all images, it is not easy to re-execute, and clustering is not frequently executed. Thus, for example, an unnatural clustering state from the user's point of view is likely to last for a long time.

In this regard, in the present embodiment, when there are a plurality of clusters (candidate clusters) serving as candidates of a cluster into which a newly received image is classified, the reconfiguration determining unit 160 decides that cluster reconfiguration is to be performed on an image classified into a candidate cluster and a newly received image. In an example illustrated in FIG. 4, the images (for example, the images P1, P2, and P3) respectively classified into the clusters C1 to C3 enter a state in which a classification into a cluster is not performed (the clusters C1 to C3 are declustered), and clustering is performed on the images and the image Pn again through the clustering unit 170. Through this operation, for example, when the image Pn is added, an appropriate cluster such as a cluster C4 is likely to be set again. Further, since a range in which clustering is re-executed is limited, compared to when clustering is performed on all images, a processing amount is small, and it is realistic as processing executed each time an image is added.

Further, the reconfiguration determining unit 160 may change a threshold value used to decide a candidate cluster according to the number of candidate clusters serving as a reconfiguration target or the number of images included in a candidate cluster serving as a reconfiguration target. For example, when the number of candidate clusters serving as a reconfiguration target is too large or when the number of images included in a candidate cluster is too large, the reconfiguration determining unit 160 may increase a threshold value (for example, perform a setting so that a cluster that is short in distance in the feature amount space is not extracted as a candidate cluster) and thus control a processing amount of clustering along with the reconfiguration in the clustering unit 170.

The clustering unit 170 executes image clustering according to the determination of the reconfiguration determining unit 160. The clustering unit 170 classifies target images into clusters based on positional information in the feature amount space represented by a vector of feature amounts. More specifically, the clustering unit 170 classifies images into clusters based on the distance between images calculated by the distance calculating unit 140 and/or the similarity score calculated by the similarity score calculating unit 150. The clustering unit 170 may execute clustering based on both the inter-image distance and similarity score or may execute clustering based on either the inter-image distance or similarity score. The clustering unit 170 provides the clustering result to the output unit 180, and stores the clustering result in the storage 130. Further, when the clustering unit 170 executes clustering based on only the inter-image distance, the server 100 may not include the similarity score calculating unit 150. For example, the clustering unit 170 is also implemented by a CPU operating according to a program stored in a memory.

Further, in the reconfiguration determining unit 160, when only one candidate cluster is extracted, the clustering unit 170 classifies a newly received image into the corresponding candidate cluster without re-executing clustering. Further, when no candidate cluster is extracted, the clustering unit 170 generates a new cluster into which a newly received image is to be classified without re-executing clustering. As described above, the clustering unit 170 executes cluster reconfiguration according to the determination of the reconfiguration determining unit 160 only if necessary, and thus it is possible to suppress a load of processing and a necessary time when a new image is added to a requisite minimum.

The output unit 180 outputs the clustering result obtained by the clustering unit 170. For example, information to be output may be information representing a cluster into which a newly received image is classified (for example, “011.jpg has been classified into category ‘you’!”). Further, when clusters are reconfigured according to the determination result of the reconfiguration determining unit 160 and the clusters into which the images previously stored in the storage 130 are classified are changed, information representing the changed cluster may be further added (for example, “classifications of 003.jpg and 005.jpg have been changed to a category “you”!). For example, the output unit 180 is implemented by a communication device that transmits a result to a terminal device or the like.

Here, the technical significance of the components in the present embodiment will be summarized. In the present embodiment, an image has the meaning of data whose position is defined in the feature amount space. When images already classified into clusters are stored in the storage 130, the images are a data group classified into clusters based on the distance (the inter-image distance calculated by the distance calculating unit 140 or the similarity score calculated by the similarity score calculating unit 150 based on the inter-image distance) in the feature amount space. In the state in which the data group is present, an image newly received by the input unit 110 is new data having positional information (positional information represented by the vector of the feature amounts extracted by the feature detecting unit 120) in the feature amount space.

Further, when new data is newly classified into a cluster into which the data group is classified, the reconfiguration determining unit 160 decides that cluster reconfiguration is to be executed on candidate clusters at the time of clustering of new data when there are a plurality of candidate clusters into which new data is classified based on the distance (the inter-image distance or the similarity score) in the feature amount space.

(1-2. Processing Flow)

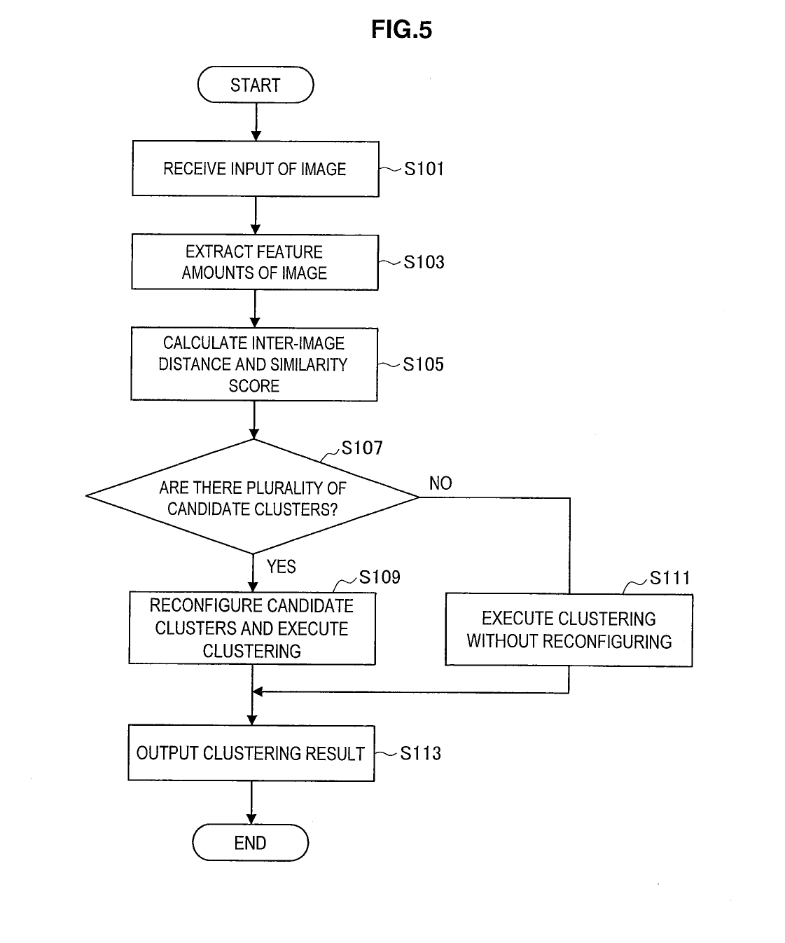

FIG. 5 is a flowchart illustrating an outline of processing of the server according to the first embodiment of the present disclosure. A configuration of the present embodiment will be described from a different point of view with reference to this flowchart.

In the server 100, first of all, the input unit 110 receives input of an image (step S101). Next, the feature detecting unit 120 extracts feature amounts of the newly received image (step S103). Further, the distance calculating unit 140 calculates the inter-image distance between the newly received image and the image previously stored in the storage 130. Further, the similarity score calculating unit 150 may calculate the similarity score based on the inter-image distance (step S105).

Here, the reconfiguration determining unit 160 determines whether or not there are a plurality of candidate clusters extracted based on the inter-image distance or similarity score, that is, whether or not there are a plurality of candidates of a cluster into which the newly received image is to be classified (step S107). Here, when it is determined that there are a plurality of candidate clusters (YES in step S107), the clustering unit 170 reconfigures the candidate clusters and executes clustering (step S109). In this case, the clustering unit 170 sets images already classified into a plurality of candidate clusters as a clustering target together with the newly received image.

Meanwhile, when it is determined in step S107 that there is only one candidate cluster or there is no candidate cluster (NO in step S107), the clustering unit 170 executes clustering without reconfiguration (step S111). In this case, the clustering unit 170 classifies the newly received image into the candidate cluster according to the inter-image distance or the similarity score or generates a new cluster and classifies the newly received image into the new cluster. Subsequently to step S109 or step S111, the output unit 180 outputs the clustering result (step S113).

Through the above process, for example, when there is a possibility that a newly received image can be added to the position of connecting clusters which are formerly set individually in the feature amount space, a cluster into which a newly received image is to be classified can be appropriately decided by reconfiguring relevant clusters and executing clustering, and an image that would be classified into the same cluster if image were originally present can be also re-classified into the same cluster. Through the determination of step S107, cluster reconfiguration is executed only if necessary, and the reconfiguration range is also limited, and thus it is possible to execute the process each time an image is added, and output a clustering result in which addition of an image is reflected in real time.

### 2. Second Embodiment

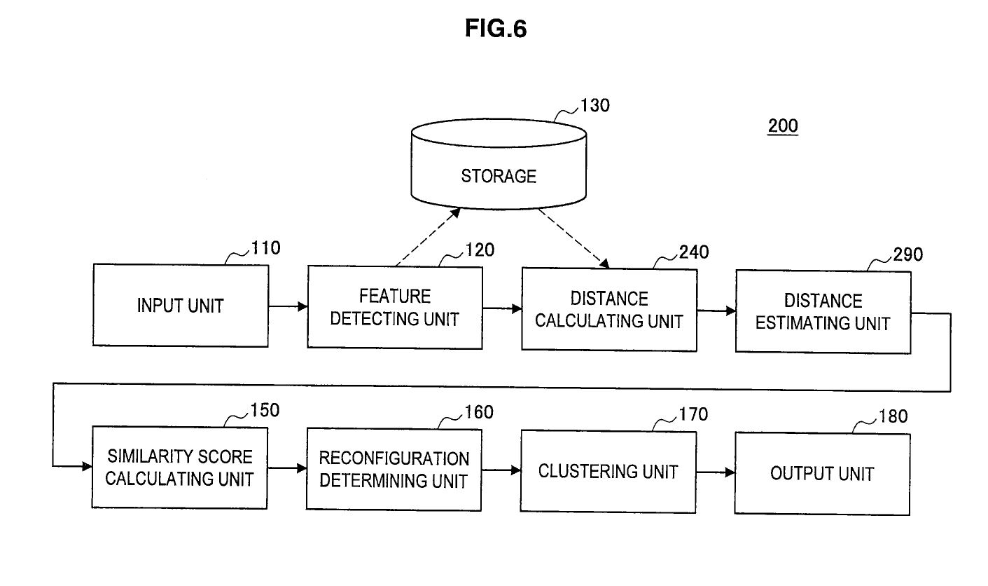

Next, a second embodiment of the present disclosure will be described with reference to FIGS. 6 to 15. The present embodiment relates to a server that receives input of an image from the user and outputs a result of clustering the image, similarly to the first embodiment. However, the present embodiment is different from the first embodiment in that a distance calculating unit calculates some inter-image distances, and the remaining inter-image distances are estimated by a distance estimating unit. Thus, the following description will proceed focusing on the different points, and a repeated description of the same configuration as in the first embodiment will be omitted.

(2-1. Functional Configuration)

FIG. 6 is a block diagram illustrating a schematic functional configuration of a server according to a second embodiment of the present disclosure. A server 200 may be implemented by a single information processing device or may be implemented by a combination of a plurality of processing devices, similarly to the server 100 according to the first embodiment. In the latter case, a functional configuration of the server 200 which will be described later may be implemented by a single information processing device or may be implemented such that a single functional component may be dispersed among a plurality of information processing devices.

The server 200 includes an input unit 110, a feature detecting unit 120, a storage 130, a distance calculating unit 240, a distance estimating unit 290, a similarity score calculating unit 150, a reconfiguration determining unit 160, a clustering unit 170, and an output unit 180 as functional components. The distance calculating unit 240 and the distance estimating unit 290 which are functional components different from those the first embodiment will be described below.

The distance calculating unit 240 calculates the inter-image distance between the image received by the input unit 110 and some images previously stored in the storage 130. The distance calculating unit 240 sets some images (target images) extracted from among images stored in the storage 130 according to a predetermined criterion as a target, and calculates the inter-image distances between the newly received image and some extracted images. For example, a target image is an image from which feature amounts used to calculate the inter-image distance can be more accurately detected, similarly to the first embodiment. Further, the distance calculating unit 240 generates a distance matrix R including the calculated inter-image distances and the inter-image distances between the images previously stored in the storage 130. For example, the distance calculating unit 240 is implemented by a CPU operating according to a program stored in a memory.

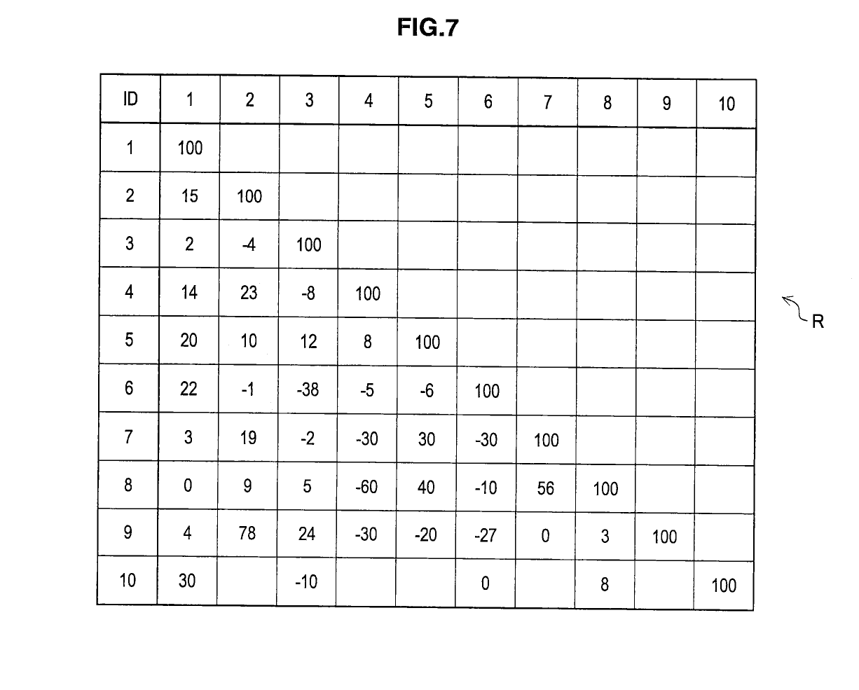

Here, an exemplary distance matrix generated by the distance calculating unit 240 is illustrated in FIG. 7. FIG. 7 is a diagram illustrating an exemplary distance matrix generated in the second embodiment of the present disclosure. In the example illustrated in FIG. 7, the inter-image distances between a newly received image (an image ID “10”) and some images (image IDs “1,” “3,” “6,” and “8”) previously stored in the storage 130 are calculated, and set as elements of the distance matrix R (a 10^{th} row). Further, the inter-image distances previously calculated on the images of the image IDs “1” to “9” are also set as elements of the distance matrix R (1^{st} to 9^{th} rows). Since only some inter-image distances are calculated for a newly received image, the distance matrix R is a matrix including an unknown element. Further, since items of a row are the same as items of a column, the distance matrix R (and a predictive distance matrix R′ which will be described later) is a symmetric matrix. Thus, for the sake of simplification, upper portions of the distance matrix R and the predictive distance matrix R′ are not illustrated.

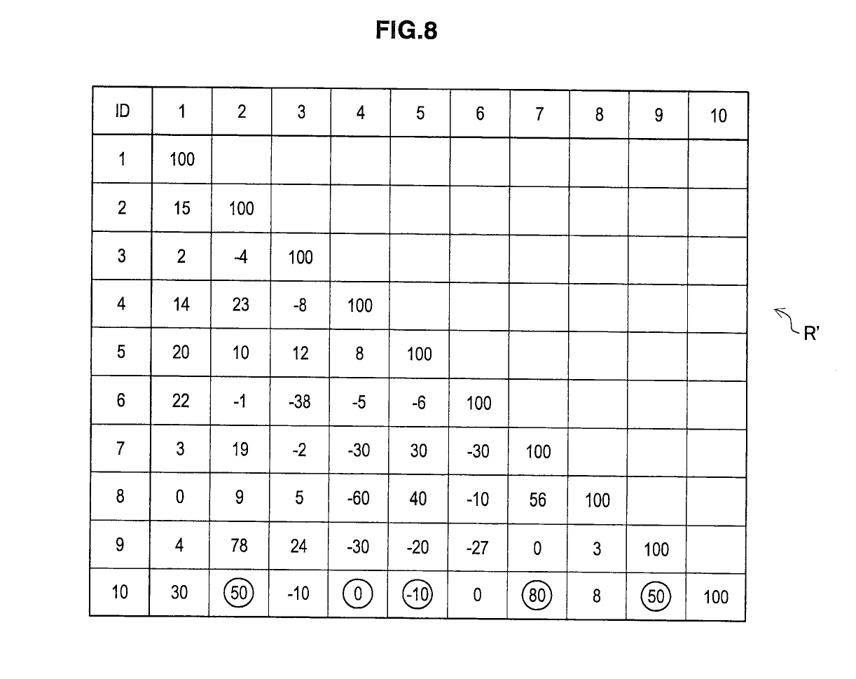

The distance estimating unit 290 calculates a prediction value of an element to which the inter-image distance calculated by the distance calculating unit 240 is not set among the elements of the distance matrix R through a matrix calculation using the distance matrix R. For example, the distance estimating unit 290 generates the predictive distance matrix R′ including prediction values (indicated by circles) of unknown elements illustrated in FIG. 8 through the matrix calculation using the distance matrix R including unknown elements, for example, illustrated in FIG. 7. FIG. 8 is a diagram illustrating an exemplary predictive distance matrix generated in the second embodiment of the present disclosure. In the example illustrated in FIG. 8, the elements excluding the prediction values of the predictive distance matrix R′ are the same as in the distance matrix R, but the elements may be slightly different in reality. A kind of a matrix calculation performed by the distance estimating unit 290 is not particularly limited, but one will be described in detail later. The distance estimating unit 290 provides the inter-image distances obtained as the prediction values of the elements of the distance matrix R to the similarity score calculating unit 150, the reconfiguration determining unit 160, or the clustering unit 170 together with the inter-image distances calculated by the distance calculating unit 240. For example, the distance estimating unit 290 is also implemented by a CPU operating according to a program stored in a memory.

(2-2. Exemplary Matrix Calculation)

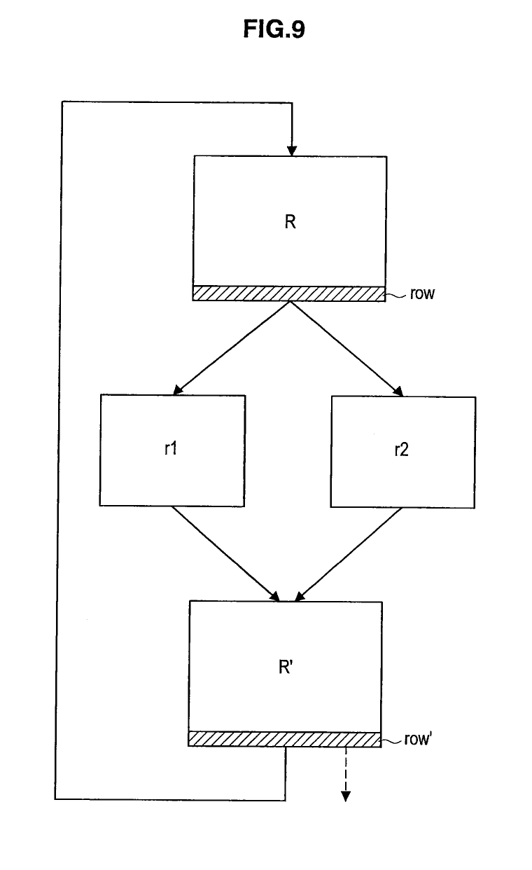

Here, an exemplary matrix calculation performed by the distance estimating unit 290 is illustrated in FIG. 9. FIG. 9 is a diagram for describing an exemplary matrix calculation in the second embodiment of the present disclosure. As illustrated in FIG. 9, the distance estimating unit 290 derives a pair of intermediate matrices r1 and r2 from the distance matrix R including a row row including an unknown element, and calculates the predictive distance matrix R′ having a row row′ including a prediction value of the unknown element by multiplying the matrices (R′=r1^{T}×r2). The distance estimating unit 290 outputs the prediction value included in the row row′ as a prediction value of the inter-image distance that was not calculated by the distance calculating unit 240. Further, the predictive distance matrix R′ is used as a portion (a portion other than the row row and a corresponding column) corresponding to the existing image of the distance matrix R when a new image is added later.

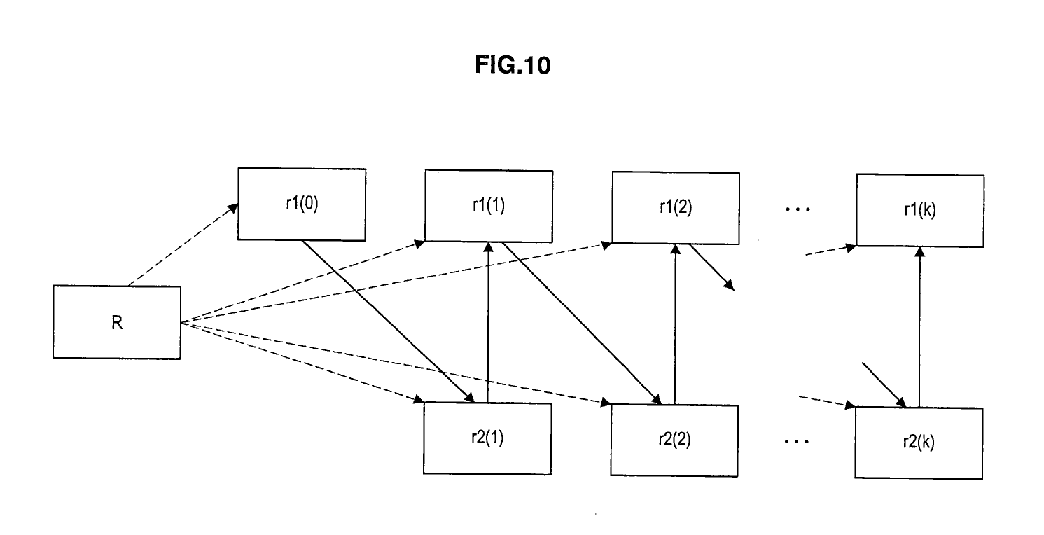

In the above matrix calculation, the intermediate matrices r1 and r2 are derived from the distance matrix R, for example, using singular value decomposition (SVD). However, when the predictive evaluation matrix R′ is initially calculated from the evaluation matrix R, it is not easy to obtain appropriate matrices as the intermediate matrices r1 and r2. In this regard, the intermediate matrices r1 and r2 are calculated, for example, through a repetitive recalculation illustrated in FIG. 10. FIG. 10 is a diagram for describing an exemplary repetitive recalculation of a matrix in the second embodiment of the present disclosure. In FIG. 10, numbers such as (0) and (1) represent the number of recalculations at that point in time.

In the example illustrated in FIG. 10, first, an intermediate matrix r1(0) is derived from the distance matrix R by singular value decomposition or the like. Next, an intermediate matrix r2(1) is derived based on the intermediate matrix r1(0) and the distance matrix R. Specifically, the intermediate matrix r1(0) is fixed, and the intermediate matrix r2(1) is decided so that an error between the predictive distance matrix R′ calculated as in r1(0)^{T}×r2(1)=R′ and the distance matrix R is minimized. Next, the intermediate matrix r2(1) is fixed, and the intermediate matrix r1(1) is decided so that an error between the predictive distance matrix R′ calculated as in r1(1)^{T}×r2(1)=R′ and the distance matrix R is minimized. Thereafter, in a similar way, a recalculation of the intermediate matrices r1 and r2 is repeated a predetermined number of times (k times), and then the predictive distance matrix R′ is calculated as in r1(k)^{T}×r2(k)=R′.

The prediction value of the unknown element included in the distance matrix R can be acquired through the above-described matrix calculation. For example, when the number of images already stored in the storage 130 is large, it is difficult to cache data of all feature amounts in a memory even in the case of images (images from which the feature amounts can be more accurately detected) extracted from among all images according to a predetermined criterion. Thus, in the distance calculating unit, when the inter-image distance with a newly received image is calculated on all target images, access to a storage is frequently performed, and a necessary time thereof is likely to increase a necessary time of overall processing.

In this regard, in the present embodiment, the distance calculating unit 240 calculates the inter-image distance on some target images, for example, as many target images as data of feature amounts thereof can be cached in a memory, and the distance estimating unit 290 estimates the inter-image distance on the remaining images. Thus, a necessary time of overall processing can be reduced. Further, the accuracy of prediction of the inter-image distance by the matrix calculation can be improved, for example, by employing the repetitive operation described above.

(2-3. Additional Exemplary Matrix Calculation)

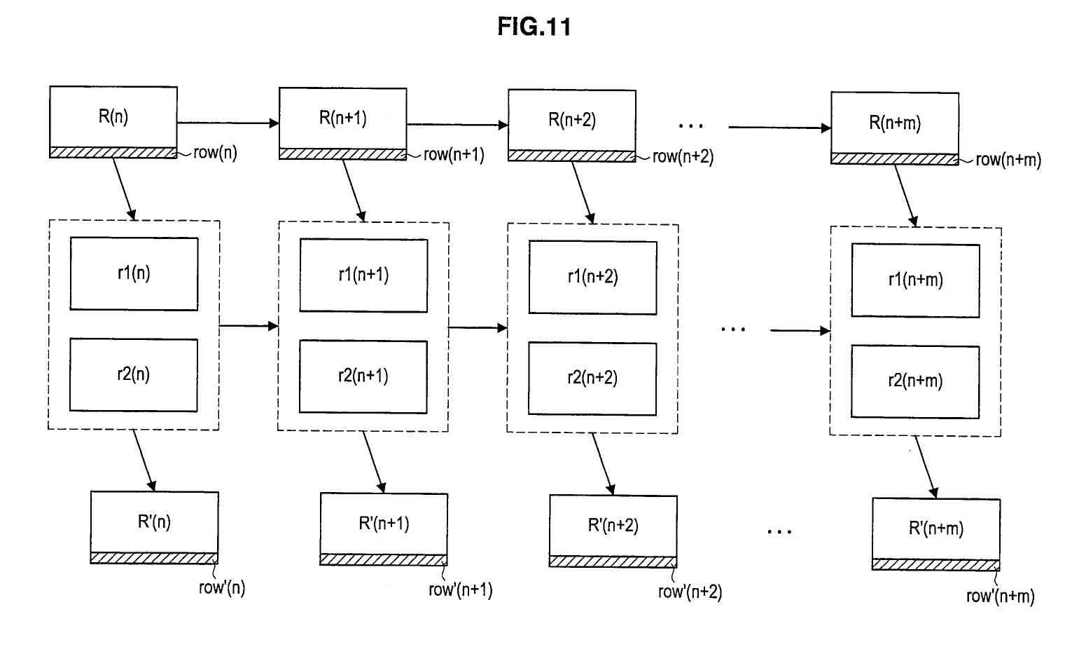

Further, as an additional configuration of the present embodiment, when an image is newly received, the distance estimating unit 290 may calculate the predictive distance matrix R′ using the previously calculated intermediate matrices r1 and r2, and in this case, the processing amount can be further suppressed. This operation will be described below with reference to FIG. 11.

### First Example

FIG. 11 is a diagram for describing a first example of an additional configuration in the second embodiment of the present disclosure. In the example illustrated in FIG. 11, in an (n^{th}) matrix calculation process at a certain point in time, intermediate matrices r1(n) and r2(n) are derived from a distance matrix R(n), and a predictive distance matrix R′(n) is calculated as in r1(n)^{T}×r2(n)=R′(n). Through this operation, a prediction value of an unknown element included in a row row(n) of the distance matrix R(n) is obtained from a row row′(n) of the predictive distance matrix R′(n).

In a next ((n+1)^{th}) matrix calculation process, intermediate matrices r1(n+1) and r2(n+1) are derived from a distance matrix R(n+1), and a predictive distance matrix R′(n+1) is calculated as in r1(n+1)^{T}×r2(n+1)=R′(n+1). Through this operation, a prediction value of an unknown element included in a row row(n+1) of the distance matrix R(n+1) is obtained from a row row′(n+1) of the predictive distance matrix R′(n+).

Here, the intermediate matrices r1(n+1) and r2(n+1) derived in the (n+1)^{th} matrix calculation process are obtained by a recalculation based on the intermediate matrices r1(n) and r2(n) derived in the n^{th} matrix calculation process. For example, in the (n+1)^{th} process, a matrix r1′ in which one row and one column are added to r1(n) is fixed, and an intermediate matrix r2(n+1) is decided so that an error between the predictive distance matrix R′ calculated as in r1′^{T}×r2(n+1)=R′ and the distance matrix R(n+1) is minimized. At this time, r2(n+1) is searched based on a matrix r2′ in which one row and one column are added to r2(n). Next, the intermediate matrix r2(n+1) is fixed, and an intermediate matrix r1(n+1) is decided so that an error between the predictive distance matrix R′ calculated as in r1(n+1)^{T}×r2(n+1)=R′ and the distance matrix R(n+1) is minimized.

In the example illustrated in FIG. 11, when the intermediate matrices r1(n+1) and r2(n+1) are obtained through a recalculation based on the intermediate matrices r1(n) and r2(n) derived in the immediately previous process, the number of recalculations of the intermediate matrices r1(n+1) and r2(n+1) may be smaller than the number (k) of repetitions in the example illustrated in FIG. 10, and may be, for example, one. In other words, in the example illustrated in FIG. 11, through the above-described process, that is, a single recalculation, the distance estimating unit 290 can derive the intermediate matrices r1(n+1) and r2(n+1) and calculate the predictive distance matrix R′(n+1) as in r1(n+1)^{T}×r2(n+1)=R′(n+1).

This example is possible because the distance matrix R(n+1) is one in which a row row(n+1) and a corresponding column of a newly added image are added to the distance matrix R(n). In other words, the distance matrix R(n+1) is the same as the distance matrix R(n) for elements other than elements in the row row(n+1) and the corresponding column. Thus, the matrix r1′ in which one row and one column are added to r1(n) and the matrix r2′ in which one row and one column are added to r21(n) are likely to approximate the intermediate matrices r1(n+1) and r2(n+1) used to calculate the distance matrix R′(n+1). Thus, the appropriate intermediate matrices r1(n+1) and r2(n+1) can be derived through a small number of recalculations when the recalculation is performed based on the matrices r1′ and r2′ instead of the matrix derived from the distance matrix R(n+1) using the SVD or the like.

In the example illustrated in FIG. 11, similarly, for the (n+2)^{th} (n+m)^{th} matrix calculation processes, the intermediate matrices r1 and r2 are obtained through the recalculation based on the intermediate matrices derived in the immediately previous matrix calculation process, and the predictive distance matrix R′ is calculated based on the intermediate matrices r1 and r2. Through this configuration, when an image is newly received, the distance estimating unit 290 can reduce the number of recalculations for calculating the predictive distance matrix R′ and reduce the processing amount.

### Second Example

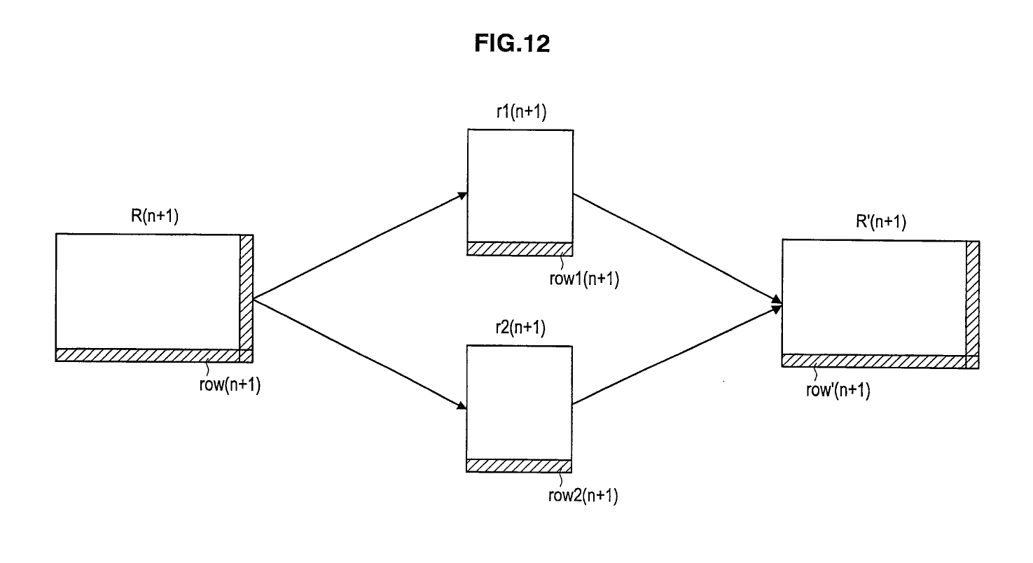

FIG. 12 is a diagram for describing a second example of an additional configuration in the second embodiment of the present disclosure. In the example illustrated in FIG. 12, when the intermediate matrices r1(n+1) and r2(n+1) are derived from the distance matrix R(n+1) and the predictive distance matrix R′(n+1) is calculated as in r1(n+1)^{T}×r2(n+1)=R′(n+1), rows serving as a recalculation target are limited to some rows of the intermediate matrices r1 and r2. This example may be employed in combination with the first example or may be employed independently.

Here, as described above, the distance matrix R(n+1) is one in which a row row(n+1) and a corresponding column of a newly added image are added to the distance matrix R(n). Thus, in the intermediate matrices r1(n+1) and r2(n+1), elements in rows other than the row and the rows row1(n+1) and row2(n+1) corresponding to the column are likely to be the same as or approximate elements in the intermediate matrices r1(n) and r2(n). Thus, in the example illustrated in FIG. 12, rows serving as a recalculation target for deriving the intermediate matrices r1(n+1) and r2(n+1) are limited to the rows row1(n+1) and row2(n+1), and the processing amount can be further suppressed.

In this example, rows serving as a recalculation target may not necessarily be rows corresponding to a newly added image. Practically, since the row row(n+1) and the corresponding column of the distance matrix R(n+1) also have influence on rows other than the rows row1(n+1) and row2(n+1) of the intermediate matrices r1(n+1) and r2(n+1), it is desirable in terms of an improvement in the accuracy of the predictive distance matrix R′ to add several rows including the rows row1(n+1) and row2(n+1) as the recalculation target. For example, one or more rows which are randomly selected may be added as a recalculation target in addition to the rows row1(n+1) and row2(n+1). Further, one or more rows which are estimated as being high in correlation with an added image based on the previously calculated inter-image distance may be added as a recalculation target.

### Third Example

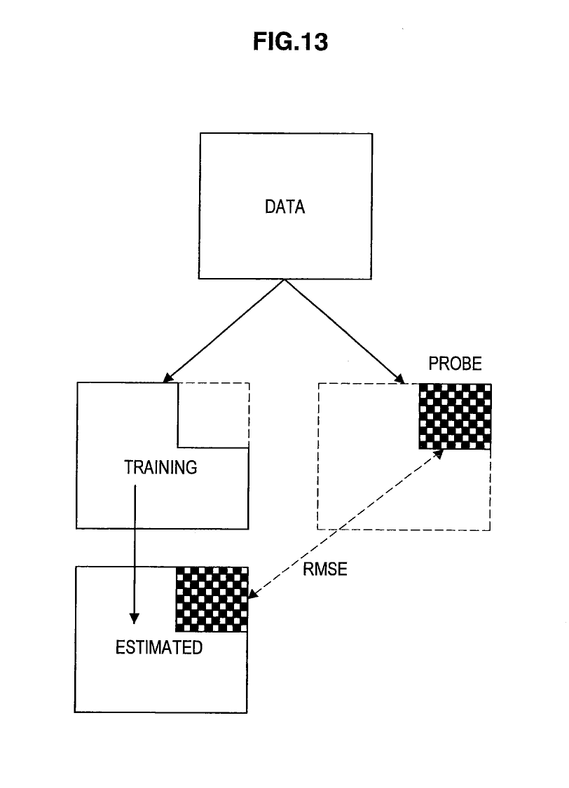

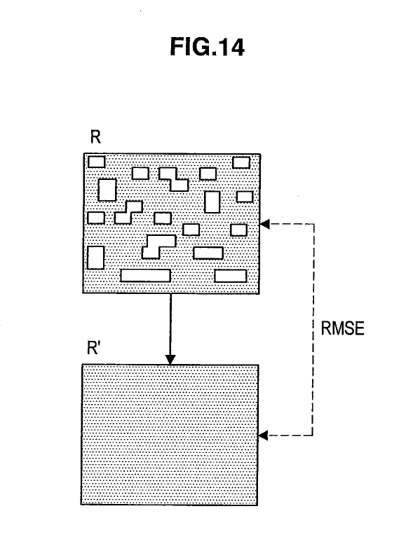

FIGS. 13 and 14 are diagrams for describing a third example of an additional configuration in the second embodiment of the present disclosure. FIG. 13 illustrates a general root mean square error (RMSE) calculation method different from that of the present embodiment, and FIG. 14 illustrates an RMSE calculation method in an example of an additional configuration of the present embodiment.

In the general calculation method, as illustrated in FIG. 13, a data matrix (DATA) is divided into a training portion (TRAINING) and a probe portion (PROBE), and a matrix calculation is performed using the training portion as an input matrix. A prediction matrix (ESTIMATED) obtained as a result of the matrix calculation includes a prediction value of the probe portion which was blank (an unknown element) in the input matrix. Element prediction accuracy by the matrix calculation can be evaluated by calculating the RMSE between the prediction value and the actual value of the probe portion.

Meanwhile, in the calculation method according to the present embodiment, as illustrated in FIG. 14, a matrix calculation is performed using the distance matrix R as the input matrix to calculate the predictive distance matrix R′, and the RMSE between a known element included in the distance matrix R and an element of the predictive distance matrix R′ corresponding to the corresponding element is calculated. When the predictive distance matrix R′ is calculated, a value is calculated by the calculation on a known element as well as an unknown element included in the distance matrix R, and thus the element prediction accuracy by the matrix calculation can be evaluated based on an error between the calculated value and an original element value of the distance matrix R.

Of the two calculation methods, a mathematically rigorous error calculation can be performed by the general calculation method. On the other hand, an error calculated by the calculation method according to the present embodiment is not as rigorous as the general calculation method. However, in the calculation method according to the present embodiment, since it is unnecessary to divide data into two portions, a calculation of a prediction value and a calculation of an error can be included in a single matrix calculation.

In the present embodiment, the distance estimating unit 290 calculates an error through the matrix calculation, and when the error exceeds a predetermined range, the predictive distance matrix R′ may be recalculated based on the distance matrix R through a repetitive calculation of a predetermined number of times (k times) illustrated in FIG. 10 without using the first and second examples. The first and second examples can suppress the processing amount by efficiently omitting a calculation, but some errors occur as a calculation is omitted. When the errors are accumulated, the accuracy of the prediction value in the predictive distance matrix R′ is likely to be lowered. Thus, it is preferable that the distance estimating unit 290 calculate the error in the matrix calculation and execute the recalculation of the predictive distance matrix R′ based on the result.

However, as the number of images stored in the storage 130 increases, the distance matrix R increases in size. Further, since images are sequentially added, the matrix calculation by the distance estimating unit 290 may be executed with a high frequency. Thus, it is not easy to perform a matrix calculation for error evaluation separately from the original matrix calculation as in the general calculation method. Meanwhile, in the calculation method of the present example, an error can be evaluated using the result of the original matrix calculation, and thus error evaluation can be executed by the distance estimating unit 290.

As described above, the error calculated by the calculation method according to the present embodiment does not compare to the general calculation method in terms of mathematical rigor. However, in the distance estimating unit 290, it is unnecessary to calculate an accurate error by an absolute reference, and it is consequential to detect a relative change tendency such as whether or not an error is increasing. Thus, in the present embodiment, the distance estimating unit 290 calculates an error of the matrix calculation through the calculation method of the present example, and determines whether or not the predictive distance matrix R′ is to be recalculated based on the error, and thus the predictive distance matrix R′ can be recalculated at an appropriate timing, and the element prediction accuracy can be maintained.

Further, the distance estimating unit 290 may determine whether or not the predictive distance matrix R′ is to be recalculated using a criterion other an error such as the RMSE. For example, the distance estimating unit 290 may decide the predictive distance matrix R′ is to be recalculated when a calculation of the predictive distance matrix R′ in which a calculation is omitted has been executed a predetermined number of times due to addition of a new image. Alternatively, the distance estimating unit 290 may decide that the predictive distance matrix R′ is to be recalculated every predetermined time period.

(2-4. Processing Flow)

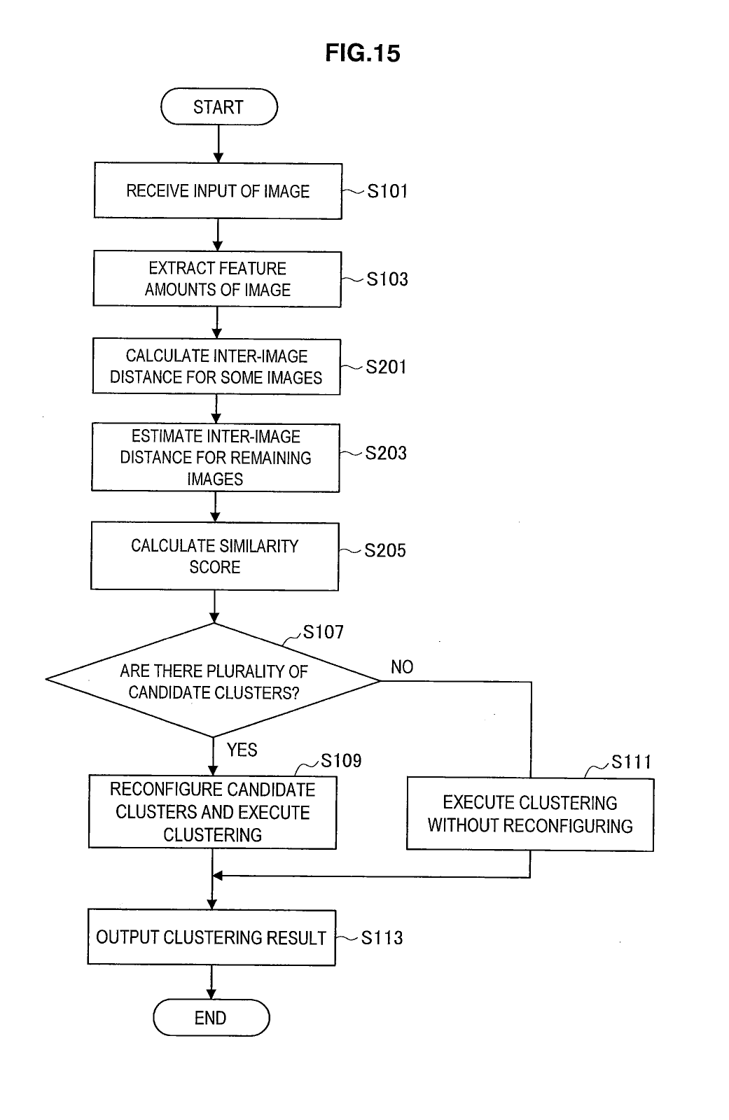

FIG. 15 is a flowchart illustrating an outline of processing of the server according to the second embodiment of the present disclosure. A configuration of the present embodiment will be described from a different point of view with reference to this flowchart.

In the server 200, first of all, the input unit 110 receives input of an image (step S101). Next, the feature detecting unit 120 extracts feature amounts of the newly received image (step S103). Further, the distance calculating unit 240 calculates the inter-image distance between the newly received image and some images previously stored in the storage 130 (step S201). Further, the distance estimating unit 290 estimates the inter-image distances for the remaining images through the matrix calculation for calculating the predictive distance matrix R′ based on the distance matrix R (step S203).

Next, the similarity score calculating unit 150 may calculate the similarity score based on the calculated or estimated inter-image distances (step S205). Similarly to the first embodiment, the calculation of the similarity score need not necessarily be performed. In this case, the clustering unit 170 executes clustering based on only the inter-image distance. The subsequent process (steps S107 to S113) is the same as in the first embodiment, and a repeated description will be omitted.

Through the above process, similarly to the first embodiment, a cluster into which a newly received image is to be classified can be appropriately decided, and an image that would be classified into the same cluster when the image were originally present can also be re-classified into the same cluster. Further, the clustering result can be output in real time.

Further, in the present embodiment, through the process of steps S201 and S203, the calculation of the inter-image distance is executed for some images stored in a storage, and the inter-image distance is estimated for the remaining images. Thus, access to the storage generated for the calculation of the inter-image distance can be suppressed, processing can be performed at a high speed, and thus the real-time property can be improved.

In addition, in the matrix calculation for estimating the inter-image distance in step S203, the number of recalculations is reduced using the immediately previous calculation result, and rows of a matrix serving as a recalculation target are limited. Thus, the processing speed can be further increased. At this time, as the recalculation (the matrix calculation in which a calculation is not omitted) is executed according to a predetermined condition, deterioration in the prediction accuracy caused due to omission of a calculation can be prevented.

(3. Hardware Configuration)

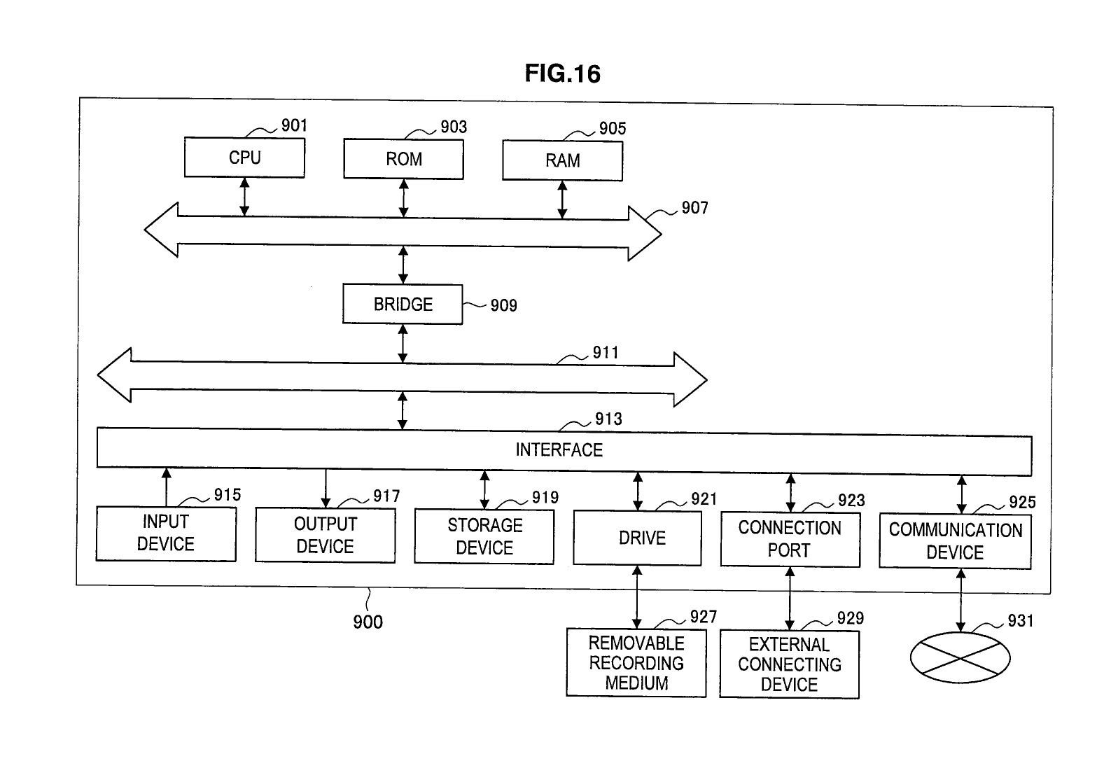

Next, a hardware configuration of an information processing device according to an embodiment of the present disclosure will be described with reference to FIG. 16. FIG. 16 is a block diagram for describing a hardware configuration of an information processing device. For example, an information processing device 900 illustrated in FIG. 12 may be implemented by one or more information processing devices that configure the server according to the above embodiments.

The information processing device 900 includes a CPU 901, a read only memory (ROM) 903, and a random access memory (RAM) 905. The information processing device 900 further includes a host bus 907, a bridge 909, an external bus 911, an interface 913, an input device 915, an output device 917, a storage device 919, a drive 921, a connection port 923, and a communication device 925. The information processing device 900 may include a processing circuit such as a digital signal processor (DSP) instead of or together with the CPU 901.

The CPU 901 functions as an arithmetic processing unit and a control device, and controls an overall operation or a part of an operation of the information processing device 900 according to various kinds of programs recorded in the ROM 903, the RAM 905, the storage device 919, or a removable recording medium 927. The ROM 903 stores a program, an operation parameter, and the like used by the CPU 901. The RAM 905 primarily stores a program used in execution of the CPU 901, a parameter that appropriately changes in the execution, and the like. The CPU 901, the ROM 903, and the RAM 905 are connected to one another via the host bus 907 configured with an internal bus such as a CPU bus. Further, the host bus 907 is connected to the external bus 911 such as a peripheral component interconnect/interface (PCI) through the bridge 909.

For example, the input device 915 is a device operated by the user such as a mouse, a keyboard, a touch panel, a button, a switch, and a lever. For example, the input device 915 may be a remote control device using an infrared ray or any other radio wave or may be an external connecting device 929 such as a mobile telephone that responds to an operation of the information processing device 900. The input device 915 includes an input/output (I/O) control circuit that generates an input signal based on information input by the user and outputs the input signal to the CPU 901. The user operates the input device 915 to input various kinds of data to the information processing device 900 or instruct the information processing device 900 to perform a processing operation.

The output device 917 is configured with a device capable of visually or auditorily notifying the user of acquired information. Examples of the output device 917 include a display device such as a liquid crystal display (LCD), a plasma display panel (PDP), an organic electro-luminescence (EL) display, an audio output device such as a speaker or headphones, and a printer device. The output device 917 outputs a video such as text or an image or a sound such as a voice or acoustics as a result obtained by processing of the information processing device 900.

The storage device 919 is a data storage device configured as an example of a storage unit of the information processing device 900. Examples of the storage device 919 include a magnetic storage device such as a hard disk drive (HDD), a semiconductor memory device, an optical storage device, and a magneto optical storage device. The storage device 919 stores a program executed by the CPU 901, various kinds of data, various kinds of data acquired from the outside, and the like.

The drive 921 is a reader/writer for the removable recording medium 927 such as a magnetic disk, an optical disc, a magneto optical disc, or a semiconductor memory, and is equipped in or externally mounted to the information processing device 900. The drive 921 reads information recorded in the mounted removable recording medium 927, and outputs the read information to the RAM 905. Further, the drive 921 writes a record in the mounted removable recording medium 927.

The connection port 923 is a port through which a device is connected directly to the information processing device 900. Examples of the connection port 923 include a universal serial bus (USB) port, an IEEE1394 port, and a small computer system interface (SCSI) port. Further, the connection port 923 may be an RS-232C port, an optical audio terminal, or a high-definition multimedia interface (HDMI) port. As the external connecting device 929 is connected to the connection port 923, various kinds of data can be exchanged between the information processing device 900 and the external connecting device 929.

For example, the communication device 925 is a communication interface configured with a communication device that provides a connection to a communication network 931. For example, the communication device 925 may be a communication card for a wired or wireless local area network (LAN), Bluetooth (a registered trademark), or a wireless USB (WUSB). Further, the communication device 925 may be a router for optical communication, a router for an asymmetric digital subscriber line (ADSL), or a modem for various kinds of communication. For example, the communication device 925 performs transmission and reception of a signal or the like with the Internet or another communication device using a predetermined protocol such as TCP/IP. Further, the communication network 931 connected to the communication device 925 is a network connected in a wired or wireless manner, and examples of the communication network 931 include the Internet, a home LAN, an infrared-ray (IR) communication network, a radio wave communication, and a satellite communication network.

The exemplary hardware configuration of the information processing device 900 has been described above. Each of the components may be configured using a generic member or may be configured with hardware specific to a function of each component. This configuration may be appropriately changed according to a technical level when implemented.

### 4. Supplement

An embodiment of the present disclosure may include the information processing device and the system described above, an information processing method executed by the information processing device or system, a program for causing the information processing device to operate, and a non-temporary recording medium including a program recorded therein.

The above embodiments have been described in connection with processing performed by the server, but an example of the present disclosure is not limited to this example. For example, when the user stores a large amount of images in a local storage and frequently adds an image and possesses a terminal device such as a personal computer (PC) with high processing capability, the above-described processing can be executed by the terminal device such as a PC used by the user. Alternatively, the above processing may be dispersedly executed by the terminal device and the server. In this case, an input unit and an output unit may be implemented by an I/O device such as a camera or a display equipped in the terminal device.

Further, in the above embodiments, an image is described as data of a processing target, but an example of the present disclosure is not limited to this example. The technology according to the present disclosure can be applied to any field as long as the position is defined in the feature amount space, and a classification into a cluster is performed based on a distance between pieces of data, and new data is data which is sequentially added. Thus, data is not limited to an image, and may be, for example, data used in various kinds of fields such as statistics, pattern recognition, and data mining.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing device, including:

a cluster reconfiguration determining unit that, in a case where new data having positional information in a feature amount space is added to a data group in which each data has positional information in the feature amount space and is classified into a cluster based on a distance in the feature amount space, decides that a candidate cluster is to be reconfigured when the new data is classified into the cluster if there are a plurality of candidate clusters into which the new data is classifiable based on the distance in the feature amount space among the clusters.

(2) The information processing device according to (1), further including:

a distance calculating unit that generates a distance matrix having a distance between data included in the data group and the new data in the feature amount space as an element, and sets a distance calculated based on the positional information in the feature amount space to some elements of the distance matrix; and

a distance estimating unit that calculates, through a matrix calculation using the distance matrix, a predictive distance matrix including a prediction value of an element of the distance matrix to which the calculated distance is not set,

wherein the cluster reconfiguration determining unit decides the candidate cluster based on the predictive distance matrix.

(3) The information processing device according to (2),

wherein the distance estimating unit generates a pair of intermediate matrices by alternately recalculating a pair of matrices derived from the distance matrix with reference to the distance matrix, and calculates the predictive distance matrix based on the pair of intermediate matrices.

(4) The information processing device according to (3),

wherein the new data includes first new data and second new data added after the first new data,

wherein the distance matrix includes a first distance matrix generated when the first new data is added and a second distance matrix generated when the second new data is added,

wherein the predictive distance matrix includes a first predictive distance matrix calculated when the first new data is added and a second predictive distance matrix calculated when the second new data is added, and

wherein the distance estimating unit causes a number of the recalculations when the second predictive distance matrix is calculated based on the second distance matrix to be smaller than a number of the recalculations when the first predictive distance matrix is calculated based on the first distance matrix, by using the pair of intermediate matrices generated when the first new data is added instead of the pair of matrices derived from the second distance matrix.

(5) The information processing device according to (4),

wherein the distance estimating unit limits a target of the recalculation when the second predictive distance matrix is calculated based on the second distance matrix to some rows including a row corresponding to a difference between the first distance matrix and the second distance matrix.

(6) The information processing device according to (5),

wherein the some rows include the row corresponding to the difference and at least one other row.

(7) The information processing device according to (6),

wherein the some rows include the row corresponding to the difference and at least one row which is high in correlation with the row corresponding to the difference.

(8) The information processing device according to any one of (4) to (7),

wherein, when a predetermined condition is satisfied, the distance estimating unit regenerates the pair of intermediate matrices by alternately recalculating a pair of matrices derived from the second distance matrix with reference to the second distance matrix, and recalculates the second predictive distance matrix based on the regenerated pair of intermediate matrices.

(9) The information processing device according to (8),

wherein the distance estimating unit recalculates the second predictive distance matrix when an error between the second distance matrix and the second predictive distance matrix exceeds a predetermined range.

(10) The information processing device according to (9),

wherein the distance estimating unit compares an element of the second distance matrix to which the calculated distance is set, with a prediction value of the corresponding element in the second predictive distance matrix, and calculates the error.

(11) The information processing device according to any one of (8) to (10),

wherein the distance estimating unit recalculates the second predictive distance matrix when a calculation of the second predictive distance matrix using the pair of intermediate matrices generated when the first new data is added instead of the pair of matrices derived from the second distance matrix has been executed a predetermined number of times.

(12) The information processing device according to any one of (8) to (11),

wherein the distance estimating unit recalculates the second predictive distance matrix every predetermined time period.

(13) The information processing device according to any one of (1) to (12),

wherein the cluster reconfiguration determining unit changes a threshold value used to decide the candidate cluster according to the number of candidate clusters serving as a reconfiguration target or a number of pieces of data included in the corresponding candidate cluster.

(14) The information processing device according to any one of (1) to (13), further including,

a similarity score calculating unit that calculates a similarity score between pieces of data based on the distance in the feature amount space,

wherein the cluster reconfiguration determining unit decides the candidate cluster based on correlation of the similarity score.

(15) The information processing device according to any one of (1) to (14), further including,

an input unit that temporally disperses and sequentially receives input of the new data.

(16) The information processing device according to any one of (1) to (15), further including:

a storage that stores an image group which is the data group;

a feature extracting unit that extracts feature amounts of a new image which is the new data;

a distance calculating unit that calculates a distance in the feature amount space between an image included in the image group and the new image;

a clustering unit that classifies the new image into a reconfigured cluster when a candidate cluster to be reconfigured is decided and classifies the new image into one of the clusters or a new cluster without reconfiguring the cluster in the other cases; and

an output unit that outputs a result of classifying the new image into a cluster.

(17) An information processing method, including:

in a case where new data having positional information in a feature amount space is added to a data group in which each data has positional information in the feature amount space and is classified into a cluster based on a distance in the feature amount space, deciding that a candidate cluster is to be reconfigured when the new data is classified into the cluster if there are a plurality of candidate clusters into which the new data is classifiable based on the distance in the feature amount space among the clusters.

(18) A program causing a computer to perform a function of, in a case where new data having positional information in a feature amount space is added to a data group in which each data has positional information in the feature amount space and is classified into a cluster based on a distance in the feature amount space, deciding that a candidate cluster is to be reconfigured when the new data is classified into the cluster if there are a plurality of candidate clusters into which the new data is classifiable based on the distance in the feature amount space among the clusters.

What is claimed is:

1. An information processing device, comprising:
a cluster reconfiguration determining unit that, in a case where new data having positional information in a feature amount space is added to a data group in which each data has positional information in the feature amount space and is classified into a cluster based on a distance in the feature amount space, decides that a candidate cluster is to be reconfigured when the new data is classified into the cluster if there are a plurality of candidate clusters into which the new data is classifiable based on the distance in the feature amount space among the clusters.

2. The information processing device according to claim 1, further comprising:
a distance calculating unit that generates a distance matrix having a distance between data included in the data group and the new data in the feature amount space as an element, and sets a distance calculated based on the positional information in the feature amount space to some elements of the distance matrix; and
a distance estimating unit that calculates, through a matrix calculation using the distance matrix, a predictive distance matrix including a prediction value of an element of the distance matrix to which the calculated distance is not set,
wherein the cluster reconfiguration determining unit decides the candidate cluster based on the predictive distance matrix.

3. The information processing device according to claim 2,
wherein the distance estimating unit generates a pair of intermediate matrices by alternately recalculating a pair of matrices derived from the distance matrix with reference to the distance matrix, and calculates the predictive distance matrix based on the pair of intermediate matrices.

4. The information processing device according to claim 3,
wherein the new data includes first new data and second new data added after the first new data,
wherein the distance matrix includes a first distance matrix generated when the first new data is added and a second distance matrix generated when the second new data is added,
wherein the predictive distance matrix includes a first predictive distance matrix calculated when the first new data is added and a second predictive distance matrix calculated when the second new data is added, and
wherein the distance estimating unit causes a number of the recalculations when the second predictive distance matrix is calculated based on the second distance matrix to be smaller than a number of the recalculations when the first predictive distance matrix is calculated based on the first distance matrix, by using the pair of intermediate matrices generated when the first new data is added instead of the pair of matrices derived from the second distance matrix.

5. The information processing device according to claim 4,
wherein the distance estimating unit limits a target of the recalculation when the second predictive distance matrix is calculated based on the second distance matrix to some rows including a row corresponding to a difference between the first distance matrix and the second distance matrix.

6. The information processing device according to claim 5,
wherein the some rows include the row corresponding to the difference and at least one other row.

7. The information processing device according to claim 6,
wherein the some rows include the row corresponding to the difference and at least one row which is high in correlation with the row corresponding to the difference.

8. The information processing device according to claim 4,
wherein, when a predetermined condition is satisfied, the distance estimating unit regenerates the pair of intermediate matrices by alternately recalculating a pair of matrices derived from the second distance matrix with reference to the second distance matrix, and recalculates the second predictive distance matrix based on the regenerated pair of intermediate matrices.

9. The information processing device according to claim 8,
wherein the distance estimating unit recalculates the second predictive distance matrix when an error between the second distance matrix and the second predictive distance matrix exceeds a predetermined range.

10. The information processing device according to claim 9,
wherein the distance estimating unit compares an element of the second distance matrix to which the calculated distance is set, with a prediction value of the corresponding element in the second predictive distance matrix, and calculates the error.

11. The information processing device according to claim 8,
wherein the distance estimating unit recalculates the second predictive distance matrix when a calculation of the second predictive distance matrix using the pair of intermediate matrices generated when the first new data is added instead of the pair of matrices derived from the second distance matrix has been executed a predetermined number of times.

12. The information processing device according to claim 8,
wherein the distance estimating unit recalculates the second predictive distance matrix every predetermined time period.

13. The information processing device according to claim 1,
wherein the cluster reconfiguration determining unit changes a threshold value used to decide the candidate cluster according to the number of candidate clusters serving as a reconfiguration target or a number of pieces of data included in the corresponding candidate cluster.

14. The information processing device according to claim 1, further comprising,
a similarity score calculating unit that calculates a similarity score between pieces of data based on the distance in the feature amount space,
wherein the cluster reconfiguration determining unit decides the candidate cluster based on correlation of the similarity score.

15. The information processing device according to claim 1, further comprising,
an input unit that temporally disperses and sequentially receives input of the new data.

16. The information processing device according to claim 1, further comprising:
a storage that stores an image group which is the data group;
a feature extracting unit that extracts feature amounts of a new image which is the new data;
a distance calculating unit that calculates a distance in the feature amount space between an image included in the image group and the new image;
a clustering unit that classifies the new image into a reconfigured cluster when a candidate cluster to be reconfigured is decided and classifies the new image into one of the clusters or a new cluster without reconfiguring the cluster in the other cases; and
an output unit that outputs a result of classifying the new image into a cluster.

17. An information processing method, comprising:
in a case where new data having positional information in a feature amount space is added to a data group in which each data has positional information in the feature amount space and is classified into a cluster based on a distance in the feature amount space, deciding that a candidate cluster is to be reconfigured when the new data is classified into the cluster if there are a plurality of candidate clusters into which the new data is classifiable based on the distance in the feature amount space among the clusters.

18. A program causing a computer to perform a function of, in a case where new data having positional information in a feature amount space is added to a data group in which each data has positional information in the feature amount space and is classified into a cluster based on a distance in the feature amount space, deciding that a candidate cluster is to be reconfigured when the new data is classified into the cluster if there are a plurality of candidate clusters into which the new data is classifiable based on the distance in the feature amount space among the clusters.
